(19) United States
(12) Patent Application Publication
(10) Pub. No.: US 2012/0277929 A1
(43) Pub. Date: Nov. 1, 2012

(54) METHOD OF INITIATING THE LOAD SHEDDING WITHIN AN ELECTRICAL POWER SYSTEM

(75) Inventors: Andrzej Wiszniewski, Wroclaw (PL); Waldemar Rebizant, Wroclaw (PL); Andrzej Klimek, Surrey (CA)

(73) Assignees: Schneider Electric Energy UK Ltd., Telford (GB); ALSTOM Technology Ltd., BADEN (CH)

(21) Appl. No.: 13/511,138

(22) PCT Filed: Dec. 2, 2009
(86) PCT No.: PCT/EP2009/066240

§ 371 Date: May 21, 2012

(51) Int. Cl. G06F 1/26

(52) U.S. Cl. 700/295

(57) ABSTRACT

A method of initiating the load shedding within an electrical power system comprising an electricity generator with a source impedance Z_{S} and a load impedance Z_{L}, characterized in that the method comprises: measuring the voltage V_{L} at the terminal of the load impedance, calculating by means of a computer a voltage operative level V_{OP} such that: V_{OP}=K V_{C}, where K is a number greater than 1 and V_{C} is a critical voltage at the terminals of the load Z_{L} at which the ratio Z_{L}/Z_{C} is equal to 1, V_{C} depending on the difference β between the phase angle θ_{L} of the load impedance Z_{L} and the phase angle θ_{S} of the source impedance Z_{S}, and comparing the voltage V_{L} with the voltage operative level V_{OP} so that the load shedding is initiated as soon as V_{L} is equal to V_{OP}.

### TECHNICAL FIELD AND PRIOR ART OF THE INVENTION

The invention relates to a method of initiating the load shedding within an electrical power system.

Disturbances in electric power system often involve several modes of instability. To limit the consequences of disturbances leading to system instability the sound detection of abnormal situation and application of the well matched preventive actions are needed. During the large scale power system disturbance, the last line of defense which prevents the voltage collapse is the load shedding at the stations where the stability margin became too low. To do that, automatic devices are needed that process local signals, detect the decreased margin and activate the load shedding.

Today, as a criterion of operation of the load shedding devices, the frequency and/or voltage criteria are adopted with either fixed and/or rate of change settings. To analyze the cases of possible voltage collapse, the fixed voltage level setting is usually adopted as a criterion quantity. Disadvantage of such an approach is due to the relations between the voltage level and the stability limit, which depends very much on the source electromotive force and load power factor. Thus shedding the load automatically, without taking this relationship into account, does not assure that the system remains stable after operation is completed. It may also shed too much load unnecessarily. Therefore, there is a need for an improved method and an apparatus for protecting power system against collapse and blackout, which obviate the aforementioned problems with conventional load shedding techniques.

The load to source impedance ratio is a good tool to determine if the stability margin is so low that some load ought to be shed. Besides, the ratio may serve as a criterion whether the transformer tap changer ought to be blocked. It is needed for preventing the system from voltage collapse in some cases, since increasing the secondary voltage decreases the primary one, thus making the stability margin shrink. U.S. Pat. No. 6,249,719 and UK patent application GB 2 450 762 both disclose methods that initiate load shedding when the difference between the load impedance and the source impedance are close to zero. More particularly, GB 2 450 762 discloses a method of monitoring stability margin within an electrical power system comprising the steps of:
establishing a dynamic power system stability margin based on an operating characteristic of the power system,
indicating that the power system has become unstable when the dynamic power system stability margin falls below a predetermined value, and
initiating dynamic load shedding and/or restoration depending on stability margin.

A drawback of the method disclosed in GB 2 450 762 is that it is necessary to calculate the load to source impedance ratio and the stability margin. The method of the invention does not have such a drawback.

### DESCRIPTION OF THE INVENTION

The invention provides a method of initiating the load shedding within an electrical power system comprising an electricity generator with a source impedance Z_{S} and a load impedance Z_{L}, the method comprising the determination of a difference β between a phase angle θ_{L} of the load impedance Z_{L} and the phase angle θ_{S} of the source impedance Z_{S}, characterized in that the method comprises:
measuring the voltage V_{L} at the terminal of the load impedance,
calculating by means of a computer a voltage operative level V_{OP} such that:

V_{OP}=K V_{C},

where K is a number greater than 1 and V_{C} is a critical voltage at the terminals of the load Z_{L} at which the ratio Z_{L}/Z_{C} is equal to 1, V_{C} depending on the difference β between the phase angle θ_{L} and the phase angle θ_{S}, and
comparing the voltage V_{L} with the voltage operative level V_{OP} so that the load shedding is initiated as soon as V_{L} is equal to V_{OP}.

According to another feature of the invention, the critical voltage V_{C} is:

V_{C}=E₁/(2+2 cos β)^{1/2},

with E₁ being a peculiar voltage at the terminals of the electricity generator.

The voltage operation level V_{OP} advantageously constantly adapted to the phase angle of the load impedance. As a result the load shedding is initiated at a certain voltage level which is greater than the critical voltage at which the stability limit is reached.

The load shedding is initiated when the stability margin becomes dangerously low. The load shedding is adjusted to the load phase angle and therefore its performance is well correlated to the stability margin. So, there is neither premature load shedding nor dangerous risk of voltage collapse.

An advantage of the method of the present invention in comparison with the method disclosed in GB 2 450 762 is that it makes the decision of load shedding based on the adopted margin between the actual voltage level and the critical voltage level, adapted to the actual load impedance, at which the stability magin level is zero. The method of the invention is advantageous in comparison with the method of GB 2 450 762 in that it is not necessary to calculate the load to source impedance ratio and the stability margin. With the method of the invention, there is also no need of determinig the voltage operating point Vop by means of a complex function which is here replaced by the critical voltage level that can be determined with less effort with much simpler equations.

### BRIEF DESCRIPTION OF THE FIGURES

Other characteristics and advantages of the invention will become clearer upon reading a preferred embodiment of the invention made in reference to the attached figure, wherein:

FIG. 1 represents an electrical circuit implementing the method of the invention; and

FIG. 2 represents voltage curves illustrating the working of the electrical circuit shown in FIG. 1.

### DETAILED DESCRIPTION OF THE PREFERRED EMBODIMENT OF THE INVENTION

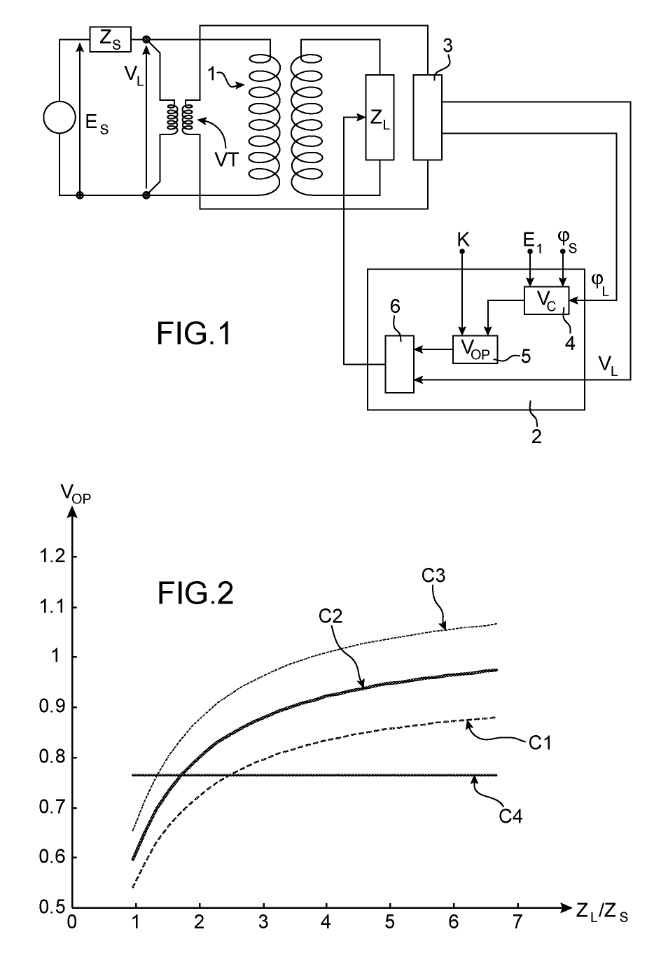

FIG. 1 represents an electrical circuit implementing the method of the invention.

The power system comprises an electricity generator (Es, Zs), a transformer 1 and a load Z_{L}. The electricity generator (E_{S}, Z_{S}) is connected between the terminals of the primary winding of the transformer 1 and the load Z_{L} is connected between the two terminals of the secondary winding of the transformer 1.

The device which implements the load shedding method of the invention comprises a computer 2, a voltage transformer VT and a measurement device 3. The computer 2 comprises a calculation unit 4 to calculate a critical voltage V_{C}, a calculation unit 5 to calculate a voltage operative level V_{OP} and a comparator 6. The measurement device 3 comprises a voltmeter that measures, via the voltage transformer VT, the voltage V_{L} between the two terminals of the load Z_{L} and a phasemeter that measures the phase angle of the load Z_{L}.

The critical voltage V_{C} is the voltage at the terminals of the load Z_{L} for which the ratio Z_{L}/Z_{S} is equal to 1. The voltage Vc is:

$${V}_{C} = \frac{{E}_{1}}{{( 2 + 2 cos β )}^{1 / 2}}$$

Where:

β=θ_{S}−θ_{L}

θ_{L} being the phase angle of Z_{L} measured by means of the measurement device 3 and θ_{S} being the phase angle of Z_{S} possibly estimated by different means (θ_{S} may be known in advance or also measured), and

E₁ is a peculiar value of the amplitude E_{S} of the electricity generator (E_{S}, Z_{S}). For the purpose of setting the relay the value E₁ has to be assumed. On the FIG. 2, E₁ is 1.05 of the rated EMF level E_{rated} (EMF for “ElectroMotive Force”) and corresponds to the curve C2. If the source voltage E_{S} is greater than the assumed value E₁ (in FIG. 2, it has been assumed that it is 1.15 of the rated EMF level, which corresponds to the curve C3) the safety margin is smaller. If it is otherwise and E_{S} is smaller then the assumed E₁ (in FIG. 2, it has been assumed 0.95 of the rated EMF level and corresponds to the curve C1), the safety margin becomes greater, what is advantageous in operation of the system.

Therefore, the input data of calculation unit 4 are E1, θS and θL.

By definition, the voltage operative level V_{OP} is assumed to be K times greater than the critical voltage V_{C}, K being a number greater than 1, i.e.:

$${V}_{OP} = {KV}_{C} = K \frac{{E}_{1}}{{( 2 + 2 cos β )}^{1 / 2}}$$

$${V}_{OP} = K \frac{{E}_{1}}{2 cos ( \frac{β}{2} )}$$

Therefore, the input data of calculation unit 5 which outputs the voltage V_{OP} are the voltage V_{C} output from the calculation unit 4 and the coefficient K which is a number greater than 1.

The three curves C1, C2, C3 of FIG. 2 represent the voltage V_{OP} as a function of Z_{L}/Z_{S} for three different values of E_{S} (0.95 E_{rated} for curve C1, 1.05 E_{rated} for curve C2 and 1.15 E_{rated} for curve C3), when the value of E₁ is assumed at the level 1.05 of the rated voltage level E_{rated}. For all the three curves, β is equal to 62° and K is equal to 1.25. A curve C4 represents the device of the invention setting. This setting represents the safety margin in terms of voltage, which makes certain that the voltage collapse shall not happen. In FIG. 2 it has been assumed, that it is 25% higher than the calculated critical voltage level for the assumed EMF being 1.05 of the rated value, but the actual setting may depend on the experience and strategy of the operators.

The comparator 6 compares the measured value V_{L} with the calculated voltage V_{OP}. The load shedding is initiated as soon as the measured voltage V_{L} is equal to the calculated voltage V_{OP}.

1. Method of initiating the load shedding within an electrical power system comprising an electricity generator with a source impedance Z_{S} and a load impedance Z_{L}, the method comprising the determination of a difference β between a phase angle θ_{L} of the load impedance Z_{L} and the phase angle θ_{S} of the source impedance Z_{S}, characterized in that the method comprises:
measuring the voltage V_{L} at the terminal of the load impedance,
calculating by means of a computer a voltage operative level V_{OP} such that:
V_{OP}=K V_{C},
where K is a number greater than 1 and V_{C} is a critical voltage at the terminals of the load Z_{L} at which the ratio Z_{L}/Z_{C} is equal to 1, V_{C} depending on the difference β between the phase angle θ_{L} and the phase angle θ_{S}, and
comparing the voltage V_{L} with the voltage operative level V_{OP} that the load shedding is initiated as soon as V_{L} is equal to V_{OP}.

2. Method according to claim 1, wherein the critical voltage V_{C} is:
V_{C}=E₁/(2+2 cos β)^{1/2},
with E₁ being a peculiar voltage at the terminals of the electricity generator.
